(19) United States
(12) Patent Application Publication
(10) Pub. No.: US 2025/0020807 A1
(43) Pub. Date: Jan. 16, 2025

(54) UNCERTAINTY-BASED DATA MINING FOR POINT CLOUD OBJECT DETECTION SYSTEMS

(71) Applicant: Apollo Autonomous Driving USA LLC, Sunnyvale, CA (US)

(72) Inventors: Hao LIU, Sunnyvale, CA (US); Yu CAO, Sunnyvale, CA (US); Ang LI, Sunnyvale, CA (US)

(21) Appl. No.: 18/350,209

(22) Filed: Jul. 11, 2023

(51) Int. Cl. G01S 17/89; G01S 17/931; G06T 7/70

(52) U.S. Cl. CPC G01S 17/89; G01S 17/931; G06T 7/70; G06T 2207/20081

(57) ABSTRACT

The present disclosure provides a system and method that analyzes, onboard an autonomous driving vehicle (ADV), a frame of LIDAR data to identify one or more obstacles in the frame of LIDAR data. The system and method compute, by a machine learning model onboard the ADV, a confidence value for each of the one or more obstacles to produce one or more confidence values, wherein the one or more confidence values indicate a level of prediction certainty of the machine learning model. The system and method determine whether at least one of the one or more confidence values is below a confidence threshold. The system and method upload the frame of LIDAR data from the ADV to an offboard storage area based on determining that at least one of the one or more confidence values is below the confidence threshold.

### TECHNICAL FIELD

Embodiments of the present disclosure relate generally to autonomous driving vehicles. More particularly, embodiments of the disclosure relate to uncertainty-based data mining for point cloud object detection systems.

### BACKGROUND

Vehicles operating in an autonomous mode (e.g., driverless) can relieve occupants, especially the driver, from some driving-related responsibilities. When operating in an autonomous mode, the vehicle can navigate to various locations using onboard sensors, allowing the vehicle to travel with minimal human interaction or in some cases without any passengers.

Light Detection and Ranging (LIDAR) systems in autonomous vehicles use a remote sensing technology that measures distances by illuminating targets with laser light and analyzing the reflected signals. LIDAR-based object detection involves using the LIDAR sensor to scan the surrounding area and generate a point cloud representation of the environment. By analyzing the characteristics of these point clouds, autonomous vehicles can detect and classify various objects such as other vehicles, pedestrians, cyclists, and obstacles.

### BRIEF DESCRIPTION OF THE DRAWINGS

Embodiments of the disclosure are illustrated by way of example and not limitation in the figures of the accompanying drawings in which like references indicate similar elements.

FIG. 1 is a block diagram illustrating a networked system according to one embodiment.

FIG. 2 is a block diagram illustrating an example of an autonomous driving vehicle according to one embodiment.

FIGS. 3 and 4 are block diagrams illustrating an example of an autonomous driving system used with an autonomous driving vehicle according to one embodiment.

FIG. 5 is a block diagram illustrating system architecture for autonomous driving according to one embodiment.

FIG. 6 is a block diagram illustrating an example of an autonomous driving data processing board according to one embodiment.

FIG. 7 is a block diagram illustrating an example of an ADS uploading LIDAR frame data based on confidence values computed by a machine learning model.

FIG. 8 is a diagram illustrating an example of a critical zone surrounding an ADV that is utilized with confidence values to determine which LIDAR frames to upload to an offboard storage area.

FIG. 9 is a diagram illustrating an example of a calibration curve for confidence graph, in accordance with some embodiments.

FIG. 10 is a diagram illustrating an example of an error rate versus k lowest confidence graph, in accordance with some embodiments.

FIG. 11 is a diagram illustrating an example of a calibration curve for an intersection of union uncertainty threshold, in accordance with some embodiments.

FIG. 12 is a diagram illustrating an example of a calibration curve for intersection of union threshold, in accordance with some embodiments.

FIG. 13 is a flow diagram of a method for uncertainty-based data mining, in accordance with some embodiments.

### DETAILED DESCRIPTION

Various embodiments and aspects of the disclosures will be described with reference to the details discussed below, and the accompanying drawings will illustrate the various embodiments. The following description and drawings are illustrative of the disclosure and are not to be construed as limiting the disclosure. Numerous specific details are described to provide a thorough understanding of various embodiments of the present disclosure. However, in certain instances, well-known or conventional details are not described in order to provide a concise discussion of embodiments of the present disclosures.

Reference in the specification to “one embodiment” or “an embodiment” means that a particular feature, structure, or characteristic described in conjunction with the embodiment can be included in at least one embodiment of the disclosure. The appearances of the phrase “in one embodiment” in various places in the specification do not necessarily all refer to the same embodiment.

As discussed above, LIDAR-based object detection involves using the LIDAR sensor to scan the surrounding area and generate a point cloud representation of the environment. Autonomous vehicles may then use machine learning models to analyze the point cloud data for tasks such as object detection, segmentation, and classification. To adequately perform these tasks, the machine learning models are trained on datasets that represent environments similar to those to which the autonomous vehicle will be exposed. Training machine learning models for point cloud analysis involves large-scale datasets with annotated point clouds. These datasets are typically created by manually labeling objects in the point clouds or by using simulation environments that generate synthetic point clouds with corresponding labels.

However, challenges exist in training machine learning models for use in autonomous driving vehicles. First, point clouds are unstructured and irregular data representations. Unlike regular grid-like data, such as images, point clouds lack a fixed pattern or order. This makes it challenging to apply traditional convolutional operations or other standard techniques used for structured data. Second, point clouds can be extremely large and dense, consisting of millions or even billions of points. Handling such large datasets requires significant computational resources and memory, and training machine learning models on dense point clouds can be time-consuming and resource intensive. Third, compared to other data types, such as images, labeled point cloud datasets are relatively limited. This scarcity of labeled data can hinder the training of machine learning models and limit their generalization capabilities. In short, autonomous vehicles do not have onboard processing resources to evaluate the point cloud data, and the amount of point cloud data is substantial so uploading all of the point cloud data for offboard analysis would require a significant amount of bandwidth.

The present disclosure provides an approach that addresses the above-noted and other deficiencies by analyzing a frame of LIDAR data onboard an autonomous driving vehicle (ADV) to identify one or more obstacles in the frame of LIDAR data. The present disclosure uses a machine learning model onboard the ADV to compute a confidence value for each of the one or more obstacles to produce one or more confidence values. The confidence values indicate a level of prediction certainty of the machine learning model. The present disclosure determines whether at least one of the one or more confidence values is below a confidence threshold. Then, when at least one of the one or more confidence values is below the confidence threshold, the present disclosure uploads the frame of LIDAR data from the ADV to an offboard storage area.

In some embodiments, the present disclosure determines a location of the obstacle relative to the ADV. The present disclosure compares the location of the obstacle to a critical zone surrounding the ADV, and performs the uploading when the location of the obstacle is within the critical zone. In some embodiments, the present disclosure cancels the uploading of the frame of LIDAR data when the location of the obstacle is outside the critical zone.

In some embodiments, the present disclosure determines an amount of uploaded LIDAR data that is uploaded to the offboard storage area over a period of time, and adjusts the confidence threshold based on comparing the amount of uploaded LIDAR data to an upload threshold.

In some embodiments, the present disclosure identifies one or more adjacent frames of LIDAR data that are adjacent to the frame of LIDAR data, and prohibits the one or more adjacent frames of LIDAR data from being uploaded to the offboard storage area. In some embodiments, the uploaded frame of LIDAR data is utilized to train the machine learning model on the one or more obstacles corresponding to the one or more confidence values that are below the confidence threshold. In some embodiments, the uploaded frame of LIDAR data is utilized to train the machine learning model on determining one or more bounding boxes of the one or more obstacles corresponding to one or more confidence values.

As discussed herein, the present disclosure provides an approach that improves the operation of a computer system by optimizing onboard machine learning models for object interpretation. The present disclosure also improves upon the technical field of autonomous vehicles by selectively uploading a subset of point cloud data from the autonomous vehicles for further machine model training, which reduces onboard processing requirements and bandwidth requirements.

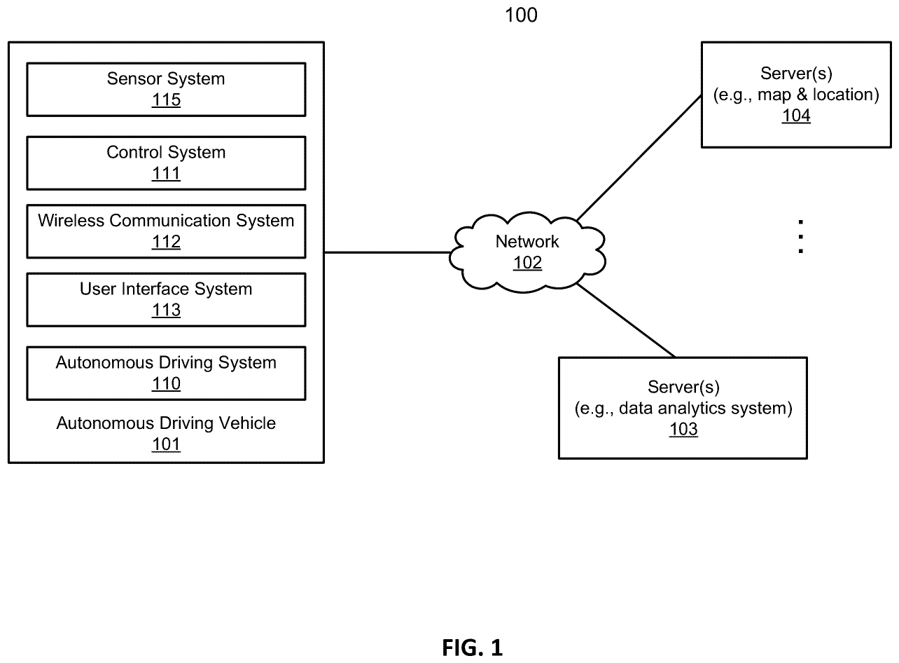

FIG. 1 is a block diagram illustrating an autonomous driving network configuration according to one embodiment of the disclosure. Referring to FIG. 1, network configuration 100 includes autonomous driving vehicle (ADV) 101 that may be communicatively coupled to one or more servers 103-104 over a network 102. Although there is one ADV shown, multiple ADVs can be coupled to each other and/or coupled to servers 103-104 over network 102. Network 102 may be any type of networks such as a local area network (LAN), a wide area network (WAN) such as the Internet, a cellular network, a satellite network, or a combination thereof, wired or wireless. Server(s) 103-104 may be any kind of servers or a cluster of servers, such as Web or cloud servers, application servers, backend servers, or a combination thereof. Servers 103-104 may be data analytics servers, content servers, traffic information servers, map and point of interest (MPOI) servers, or location servers, etc.

An ADV refers to a vehicle that can be configured to in an autonomous mode in which the vehicle navigates through an environment with little or no input from a driver. Such an ADV can include a sensor system having one or more sensors that are configured to detect information about the environment in which the vehicle operates. The vehicle and its associated controller(s) use the detected information to navigate through the environment. ADV 101 can operate in a manual mode, a full autonomous mode, or a partial autonomous mode.

In one embodiment, ADV 101 includes, but is not limited to, autonomous driving system (ADS) 110, vehicle control system 111, wireless communication system 112, user interface system 113, and sensor system 115. ADV 101 may further include certain common components included in ordinary vehicles, such as, an engine, wheels, steering wheel, transmission, etc., which may be controlled by vehicle control system 111 and/or ADS 110 using a variety of communication signals and/or commands, such as, for example, acceleration signals or commands, deceleration signals or commands, steering signals or commands, braking signals or commands, etc.

Components 110-115 may be communicatively coupled to each other via an interconnect, a bus, a network, or a combination thereof. For example, components 110-115 may be communicatively coupled to each other via a controller area network (CAN) bus. A CAN bus is a vehicle bus standard designed to allow microcontrollers and devices to communicate with each other in applications without a host computer. It is a message-based protocol, designed originally for multiplex electrical wiring within automobiles, but is also used in many other contexts.

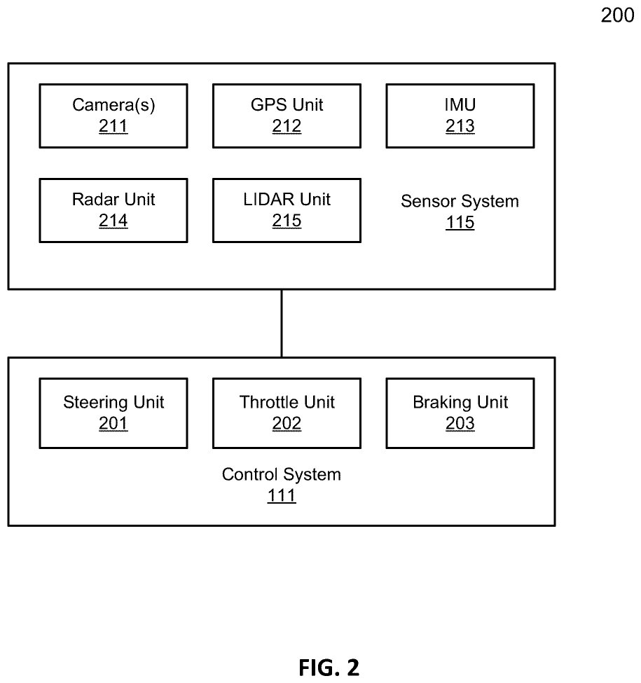

Referring now to FIG. 2, in one embodiment, sensor system 115 includes, but it is not limited to, one or more cameras 211, global positioning system (GPS) unit 212, inertial measurement unit (IMU) 213, radar unit 214, and a light detection and range (LIDAR) unit 215. GPS system 212 may include a transceiver operable to provide information regarding the position of the ADV. IMU unit 213 may sense position and orientation changes of the ADV based on inertial acceleration. Radar unit 214 may represent a system that utilizes radio signals to sense objects within the local environment of the ADV. In some embodiments, in addition to sensing objects, radar unit 214 may additionally sense the speed and/or heading of the objects. LIDAR unit 215 may sense objects in the environment in which the ADV is located using lasers. LIDAR unit 215 could include one or more laser sources, a laser scanner, and one or more detectors, among other system components. Cameras 211 may include one or more devices to capture images of the environment surrounding the ADV. Cameras 211 may be still cameras and/or video cameras. A camera may be mechanically movable, for example, by mounting the camera on a rotating and/or tilting a platform.

Sensor system 115 may further include other sensors, such as, a sonar sensor, an infrared sensor, a steering sensor, a throttle sensor, a braking sensor, and an audio sensor (e.g., microphone). An audio sensor may be configured to capture sound from the environment surrounding the ADV. A steering sensor may be configured to sense the steering angle of a steering wheel, wheels of the vehicle, or a combination thereof. A throttle sensor and a braking sensor sense the throttle position and braking position of the vehicle, respectively. In some situations, a throttle sensor and a braking sensor may be integrated as an integrated throttle/braking sensor.

In one embodiment, vehicle control system 111 includes, but is not limited to, steering unit 201, throttle unit 202 (also referred to as an acceleration unit), and braking unit 203. Steering unit 201 is to adjust the direction or heading of the vehicle. Throttle unit 202 is to control the speed of the motor or engine that in turn controls the speed and acceleration of the vehicle. Braking unit 203 is to decelerate the vehicle by providing friction to slow the wheels or tires of the vehicle. Note that the components as shown in FIG. 2 may be implemented in hardware, software, or a combination thereof.

Referring back to FIG. 1, wireless communication system 112 is to allow communication between ADV 101 and external systems, such as devices, sensors, other vehicles, etc. For example, wireless communication system 112 can wirelessly communicate with one or more devices directly or via a communication network, such as servers 103-104 over network 102. Wireless communication system 112 can use any cellular communication network or a wireless local area network (WLAN), e.g., using WiFi to communicate with another component or system. Wireless communication system 112 could communicate directly with a device (e.g., a mobile device of a passenger, a display device, a speaker within vehicle 101), for example, using an infrared link, Bluetooth, etc. User interface system 113 may be part of peripheral devices implemented within vehicle 101 including, for example, a keyboard, a touch screen display device, a microphone, and a speaker, etc.

Some or all of the functions of ADV 101 may be controlled or managed by ADS 110, especially when operating in an autonomous driving mode. ADS 110 includes the necessary hardware (e.g., processor(s), memory, storage) and software (e.g., operating system, planning and routing programs) to receive information from sensor system 115, control system 111, wireless communication system 112, and/or user interface system 113, process the received information, plan a route or path from a starting point to a destination point, and then drive vehicle 101 based on the planning and control information. Alternatively, ADS 110 may be integrated with vehicle control system 111.

For example, a user as a passenger may specify a starting location and a destination of a trip, for example, via a user interface. ADS 110 obtains the trip related data. For example, ADS 110 may obtain location and route data from an MPOI server, which may be a part of servers 103-104. The location server provides location services and the MPOI server provides map services and the POIs of certain locations. Alternatively, such location and MPOI information may be cached locally in a persistent storage device of ADS 110.

While ADV 101 is moving along the route, ADS 110 may also obtain real-time traffic information from a traffic information system or server (TIS). Note that servers 103-104 may be operated by a third party entity. Alternatively, the functionalities of servers 103-104 may be integrated with ADS 110. Based on the real-time traffic information, MPOI information, and location information, as well as real-time local environment data detected or sensed by sensor system 115 (e.g., obstacles, objects, nearby vehicles), ADS 110 can plan an optimal route and drive vehicle 101, for example, via control system 111, according to the planned route to reach the specified destination safely and efficiently.

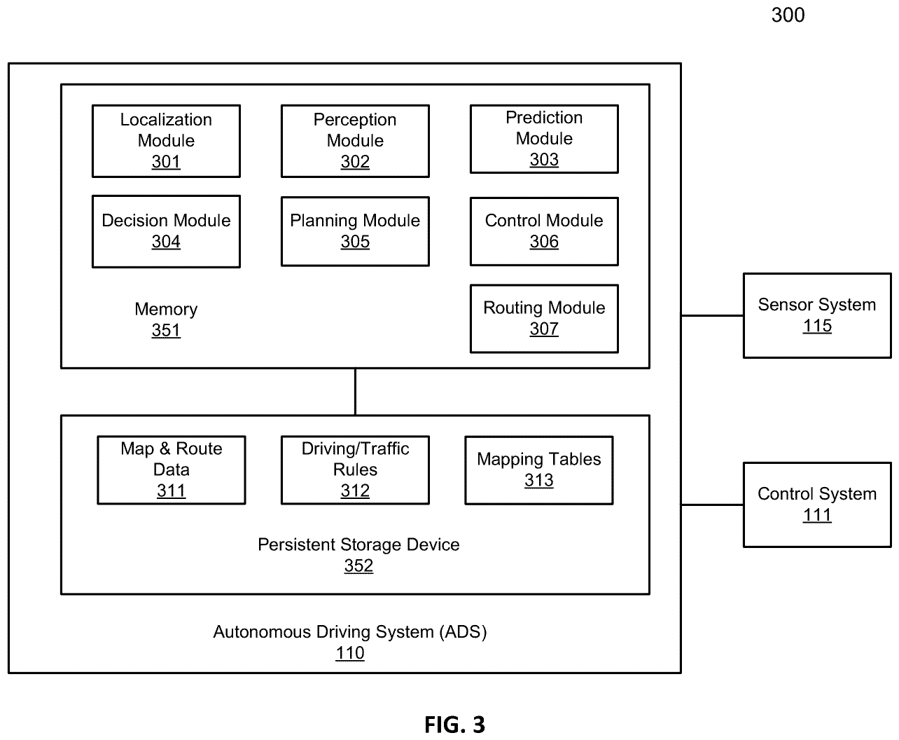

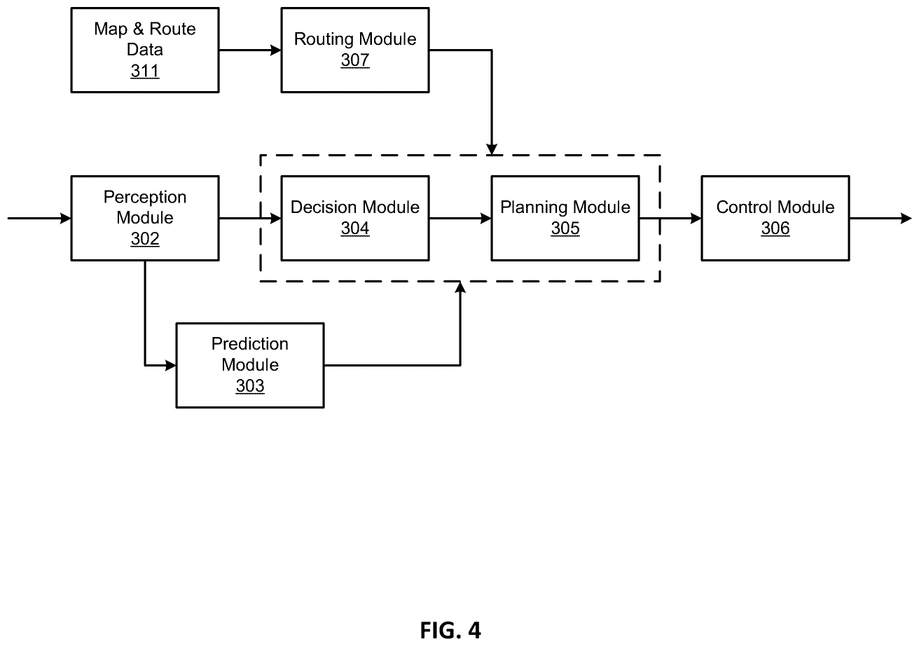

FIGS. 3 and 4 are block diagrams illustrating an example of an autonomous driving system used with an ADV according to one embodiment. System 300 may be implemented as a part of ADV 101 of FIG. 1 including, but is not limited to, ADS 110, control system 111, and sensor system 115. ADS 110 includes, but is not limited to, localization module 301, perception module 302, prediction module 303, decision module 304, planning module 305, control module 306, and routing module 307.

Some or all of modules 301-307 may be implemented in software, hardware, or a combination thereof. For example, these modules may be installed in persistent storage device 352, loaded into memory 351, and executed by one or more processors (not shown). Note that some or all of these modules may be communicatively coupled to or integrated with some or all modules of vehicle control system 111 of FIG. 2. Some of modules 301-307 may be integrated together as an integrated module.

Localization module 301 determines a current location of ADV 300 (e.g., leveraging GPS unit 212) and manages any data related to a trip or route of a user. Localization module 301 (also referred to as a map and route module) manages any data related to a trip or route of a user. A user may log in and specify a starting location and a destination of a trip, for example, via a user interface. Localization module 301 communicates with other components of ADV 300, such as map and route data 311, to obtain the trip related data. For example, localization module 301 may obtain location and route data from a location server and a map and POI (MPOI) server. A location server provides location services and an MPOI server provides map services and the POIs of certain locations, which may be cached as part of map and route data 311. While ADV 300 is moving along the route, localization module 301 may also obtain real-time traffic information from a traffic information system or server.

Based on the sensor data provided by sensor system 115 and localization information obtained by localization module 301, a perception of the surrounding environment is determined by perception module 302. The perception information may represent what an ordinary driver would perceive surrounding a vehicle in which the driver is driving. The perception can include the lane configuration, traffic light signals, a relative position of another vehicle, a pedestrian, a building, crosswalk, or other traffic related signs (e.g., stop signs, yield signs), etc., for example, in a form of an object. The lane configuration includes information describing a lane or lanes, such as, for example, a shape of the lane (e.g., straight or curvature), a width of the lane, how many lanes in a road, one-way or two-way lane, merging or splitting lanes, exiting lane, etc.

Perception module 302 may include a computer vision system or functionalities of a computer vision system to process and analyze images captured by one or more cameras in order to identify objects and/or features in the environment of the ADV. The objects can include traffic signals, roadway boundaries, other vehicles, pedestrians, and/or obstacles, etc. The computer vision system may use an object recognition algorithm, video tracking, and other computer vision techniques. In some embodiments, the computer vision system can map an environment, track objects, and estimate the speed of objects, etc. Perception module 302 can also detect objects based on other sensors data provided by other sensors such as a radar and/or LIDAR.

For each of the objects, prediction module 303 predicts what the object will behave under the circumstances. The prediction is performed based on the perception data perceiving the driving environment at the point in time in view of a set of map/route information 311 and traffic rules 312. For example, if the object is a vehicle at an opposing direction and the current driving environment includes an intersection, prediction module 303 will predict whether the vehicle will likely move straight forward or make a turn. If the perception data indicates that the intersection has no traffic light, prediction module 303 may predict that the vehicle may have to fully stop prior to enter the intersection. If the perception data indicates that the vehicle is currently at a left-turn only lane or a right-turn only lane, prediction module 303 may predict that the vehicle will more likely make a left turn or right turn respectively.

For each of the objects, decision module 304 decides how to handle the object. For example, for a particular object (e.g., another vehicle in a crossing route) as well as its metadata describing the object (e.g., a speed, direction, turning angle), decision module 304 decides how to encounter the object (e.g., overtake, yield, stop, pass). Decision module 304 may make such decisions according to a set of rules such as traffic rules or driving rules 312, which may be stored in persistent storage device 352.

Routing module 307 is configured to provide one or more routes or paths from a starting point to a destination point. For a given trip from a start location to a destination location, for example, received from a user, routing module 307 obtains route and map information 311 and determines all possible routes or paths from the starting location to reach the destination location. Routing module 307 may generate a reference line in a form of a topographic map for each of the routes it determines from the starting location to reach the destination location. A reference line refers to an ideal route or path without any interference from others such as other vehicles, obstacles, or traffic condition. That is, if there is no other vehicle, pedestrians, or obstacles on the road, an ADV should exactly or closely follows the reference line. The topographic maps are then provided to decision module 304 and/or planning module 305. Decision module 304 and/or planning module 305 examine all of the possible routes to select and modify one of the most optimal routes in view of other data provided by other modules such as traffic conditions from localization module 301, driving environment perceived by perception module 302, and traffic condition predicted by prediction module 303. The actual path or route for controlling the ADV may be close to or different from the reference line provided by routing module 307 dependent upon the specific driving environment at the point in time.

Based on a decision for each of the objects perceived, planning module 305 plans a path or route for the ADV, as well as driving parameters (e.g., distance, speed, and/or turning angle), using a reference line provided by routing module 307 as a basis. That is, for a given object, decision module 304 decides what to do with the object, while planning module 305 determines how to do it. For example, for a given object, decision module 304 may decide to pass the object, while planning module 305 may determine whether to pass on the left side or right side of the object. Planning and control data is generated by planning module 305 including information describing how vehicle 101 would move in a next moving cycle (e.g., next route/path segment). For example, the planning and control data may instruct vehicle 101 to move 10 meters at a speed of 30 miles per hour (mph), then change to a right lane at the speed of 25 mph.

Based on the planning and control data, control module 306 controls and drives the ADV, by sending proper commands or signals to vehicle control system 111, according to a route or path defined by the planning and control data. The planning and control data include sufficient information to drive the vehicle from a first point to a second point of a route or path using appropriate vehicle settings or driving parameters (e.g., throttle, braking, steering commands) at different points in time along the path or route.

In one embodiment, the planning phase is performed in a number of planning cycles, also referred to as driving cycles, such as, for example, in every time interval of 100 milliseconds (ms). For each of the planning cycles or driving cycles, one or more control commands will be issued based on the planning and control data. That is, for every 100 ms, planning module 305 plans a next route segment or path segment, for example, including a target position and the time required for the ADV to reach the target position. Alternatively, planning module 305 may further specify the specific speed, direction, and/or steering angle, etc. In one embodiment, planning module 305 plans a route segment or path segment for the next predetermined period of time such as 5 seconds. For each planning cycle, planning module 305 plans a target position for the current cycle (e.g., next 5 seconds) based on a target position planned in a previous cycle. Control module 306 then generates one or more control commands (e.g., throttle, brake, steering control commands) based on the planning and control data of the current cycle.

Note that decision module 304 and planning module 305 may be integrated as an integrated module. Decision module 304/planning module 305 may include a navigation system or functionalities of a navigation system to determine a driving path for the ADV. For example, the navigation system may determine a series of speeds and directional headings to affect movement of the ADV along a path that substantially avoids perceived obstacles while generally advancing the ADV along a roadway-based path leading to an ultimate destination. The destination may be set according to user inputs via user interface system 113. The navigation system may update the driving path dynamically while the ADV is in operation. The navigation system can incorporate data from a GPS system and one or more maps so as to determine the driving path for the ADV.

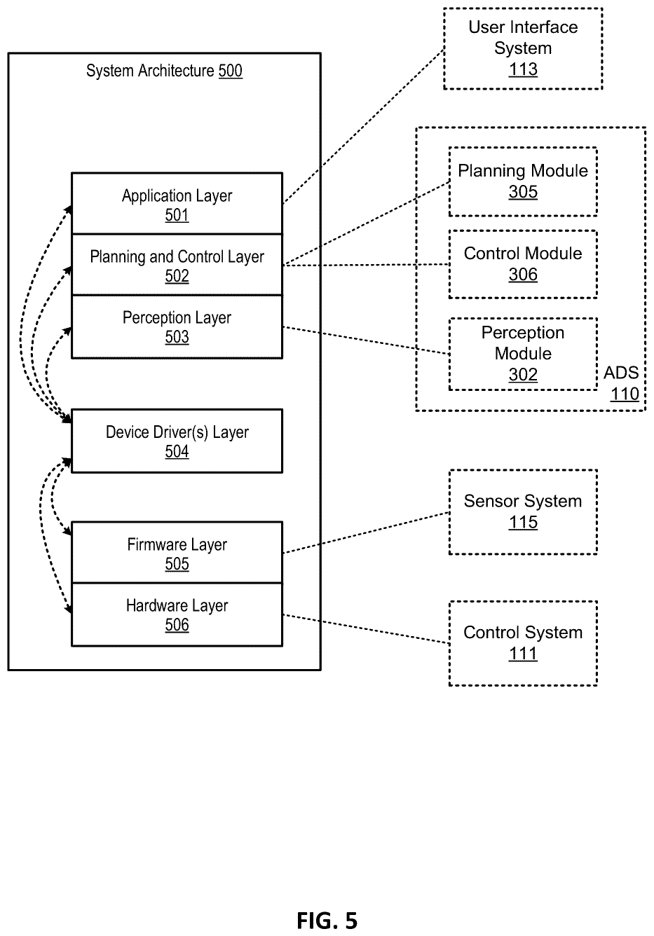

FIG. 5 is a block diagram illustrating system architecture for autonomous driving according to one embodiment. System architecture 500 may represent system architecture of an autonomous driving system as shown in FIG. 1. Referring to FIG. 5, system architecture 500 includes, but it is not limited to, application layer 501, planning and control (PNC) layer 502, perception layer 503, driver layer 504, firmware layer 505, and hardware layer 506. Application layer 501 may include user interface or configuration application that interacts with users or passengers of an autonomous driving vehicle, such as, for example, functionalities associated with user interface system 113. PNC layer 502 may include functionalities of planning module 305 and control module 306. Perception layer 503 may include functionalities of at least perception module 302. Firmware layer 505 may represent at least the functionality of sensor system 115, which may be implemented in a form of a field programmable gate array (FPGA). Hardware layer 506 may represent the hardware of the autonomous driving vehicle such as control system 111. Layers 501-503 can communicate with firmware layer 505 and hardware layer 506 via device driver layer 504.

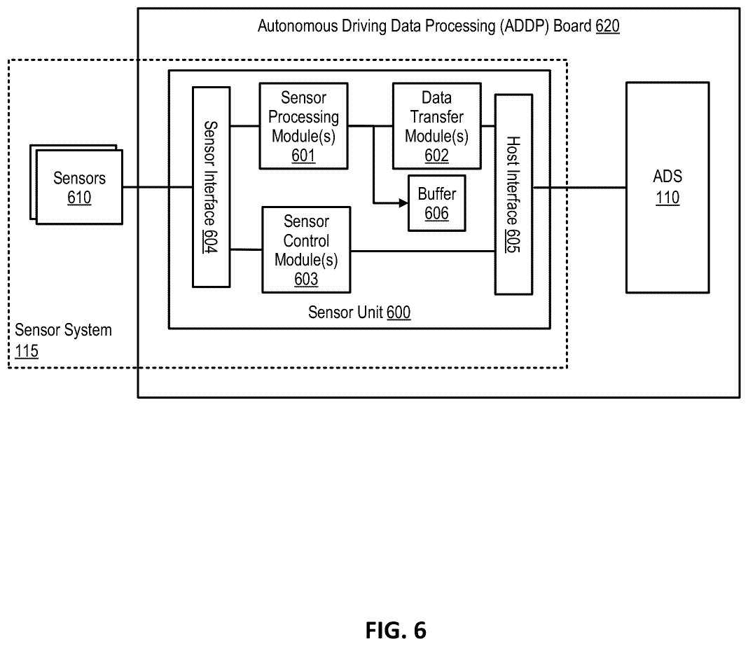

FIG. 6 is a block diagram illustrating an example of an autonomous driving data processing board according to one embodiment. Referring to FIG. 6, sensor system 115 includes a number of sensors 610 and a sensor unit 600 coupled to ADS 110. ADS 110 may include at least some of the modules as shown in FIG. 3. Sensor unit 600 may be configured, for example, in a form of an FPGA device or an ASIC (application specific integrated circuit) device. In one embodiment, sensor unit 600 includes, amongst others, one or more sensor data processing modules 601 (also simply referred to as sensor processing modules), data transfer modules 602, and sensor control modules or logic 603. Modules 601-603 can communicate with sensors 610 via a sensor interface 604 and communicate with ADS 110 via host interface 605. Optionally, an internal or external buffer 606 may be utilized for buffering the data for processing.

In one embodiment, sensors 610 may include a GPS receiver/unit, an IMU, and a LIDAR unit. The GPS unit and IMU may be coupled together with a sensor unit 600 on a single FPGA, or ASIC, referred to as an inertial measurement unit (INS). In one embodiment, sensors 610 include a first IMU as a primary IMU and a second IMU as a redundant or backup IMU, which may be independently powered by separate power supply circuits (such as voltage regulators). The sensor processing module 601 may include logic to receive data from the GPS unit and the IMU and combine the data (e.g., using a Kalman filter) to estimate a location of the automated vehicle. The sensor processing module 601 may further include logic to compensate for GPS data bias due to propagation latencies of the GPS data.

In one embodiment, for the receiving path or upstream direction, sensor processing module 601 is configured to receive sensor data from a sensor via sensor interface 604 and process the sensor data (e.g., format conversion, error checking), which may be temporarily stored in buffer 606. Data transfer module 602 is configured to transfer the processed data to ADS 110 using a communication protocol compatible with host interface 605. Similarly, for the transmitting path or downstream direction, data transfer module 602 is configured to receive data or commands from ADS 110. The data is then processed by sensor processing module 601 to a format that is compatible with the corresponding sensor. The processed data is then transmitted to the sensor.

In one embodiment, sensor control module or logic 603 is configured to control certain operations of sensors 610, such as, for example, timing of activation of capturing sensor data, in response to commands received from host system (e.g., perception module 302) via host interface 605. ADS 110 can configure sensors 610 to capture sensor data in a collaborative and/or synchronized manner, such that the sensor data can be utilized to perceive a driving environment surrounding the vehicle at any point in time.

Sensor interface 604 can include one or more of Ethernet, USB (universal serial bus), LTE (long term evolution) or cellular, WiFi, GPS, camera, CAN, serial (e.g., universal asynchronous receiver transmitter or UART), SIM (subscriber identification module) card, and other general purpose input/output (GPIO) interfaces. Host interface 605 may be any high speed or high bandwidth interface such as PCIe (peripheral component interconnect or PCI express) interface. Sensors 610 can include a variety of sensors that are utilized in an ADV, such as, for example, a camera, a RADAR device, a GPS receiver, an IMU, an ultrasonic sensor, a GNSS (global navigation satellite system) receiver, an LTE or cellular SIM card, vehicle sensors (e.g., throttle, brake, steering sensors), and system sensors (e.g., temperature, humidity, pressure sensors), etc.

For example, a camera can be coupled via an Ethernet or a GPIO interface. A GPS sensor can be coupled via a USB or a specific GPS interface. Vehicle sensors can be coupled via a CAN interface. A RADAR sensor or an ultrasonic sensor can be coupled via a GPIO interface. Similarly, an internal SIM module can be inserted onto a SIM socket of sensor unit 600. The serial interface such as UART can be coupled with a console system for debug purposes.

Sensors 610 can be any kind of sensors and provided by various vendors or suppliers. Sensor processing module 601 is configured to handle different types of sensors and their respective data formats and communication protocols. According to one embodiment, each of sensors 610 is associated with a specific channel for processing sensor data and transferring the processed sensor data between ADS 110 and the corresponding sensor. Each channel may include a specific sensor processing module and a specific data transfer module that have been configured or programmed to handle the corresponding sensor data and protocol.

Autonomous driving data processing (ADDP) board 620, in one embodiment, includes sensor unit and ADS 110. ADDP board 620 includes various hardware components and software execution capabilities to perform the functions described herein regarding ADS 110 and sensor system 115 less sensors 610.

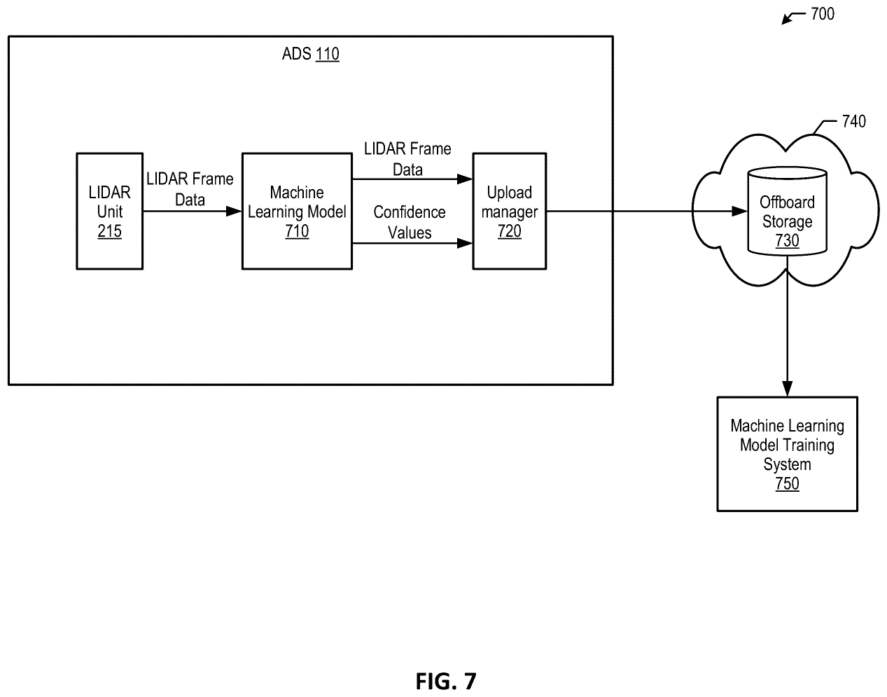

FIG. 7 is a block diagram illustrating an example of an autonomous driving system that determines LIDAR frame data, also referred to as frame of LIDAR data, to upload based on confidence values computed by a machine learning model.

System 700 includes ADS 110, offboard storage 730 in cloud 740, and machine learning model training system 750. ADS 110 includes LIDAR unit 215 discussed previously, which produces LIDAR frame data. In a LIDAR frame, the LIDAR sensor emits laser pulses in different directions, and when these pulses hit objects in the environment, they are reflected back to the sensor. The sensor measures the time it takes for the pulses to return and calculates the distance to each object based on the speed of light. By scanning the laser beams across the field of view, the LIDAR sensor creates a three-dimensional representation of the surrounding environment.

The LIDAR frame data feeds into machine learning model 710, and machine learning model 710 computes confidence values for each obstacle in the LIDAR frame data. The confidence values indicate an amount of certainty that machine learning model 710 has in predicting the type of an object. The amount of certainty, also referred to as uncertainty, is utilized by upload manager 720 for data mining, particularly uncertainty mining. Data mining is a process of extracting valuable information from raw data, transforming the data into a usable format, and making the data ready for analysis. Uncertainty mining is a type of data mining and refers to the process of analyzing and extracting insights from data that contain inherent uncertainty or imprecision.

In some embodiments, a challenge of onboard data mining lies in the limited computing resources of computing power in ADS 110. As such, upload manager 720 may focus on the obstacles with the highest uncertainty. Assuming that the machine learning model 710 is M and there are multiple obstacle positions in the current LIDAR frame data of P=(p1, p2, . . . , pN), the confidence level for each position (rectangular box) is Ck=M (pk), and the confidence level for the entire frame is C=min (C1, C2, . . . , CN), wherein the criteria for uploading the current frame are C<T where T is the confidence threshold.

Upload manager 720 compares the confidence values from machine learning model 710 against the confidence threshold to determine which LIDAR frame data should be uploaded to offboard storage 730 in cloud 740. When one of the confidence values of the objects is lower than the confidence threshold, upload manager 720 uploads the corresponding LIDAR frame data to offboard storage 730. In some embodiments, upload manager 720 segments out the LIDAR frame data corresponding to an obstacle corresponding to a low confidence value and uploads the segmented LIDAR frame data to offboard storage 730. In some embodiments, sending the entire LIDAR frame data or a segment of the LIDAR frame data is determined based on the amount of processing resources in ADS 110 relative to the amount of bandwidth available to upload data to offboard storage 730.

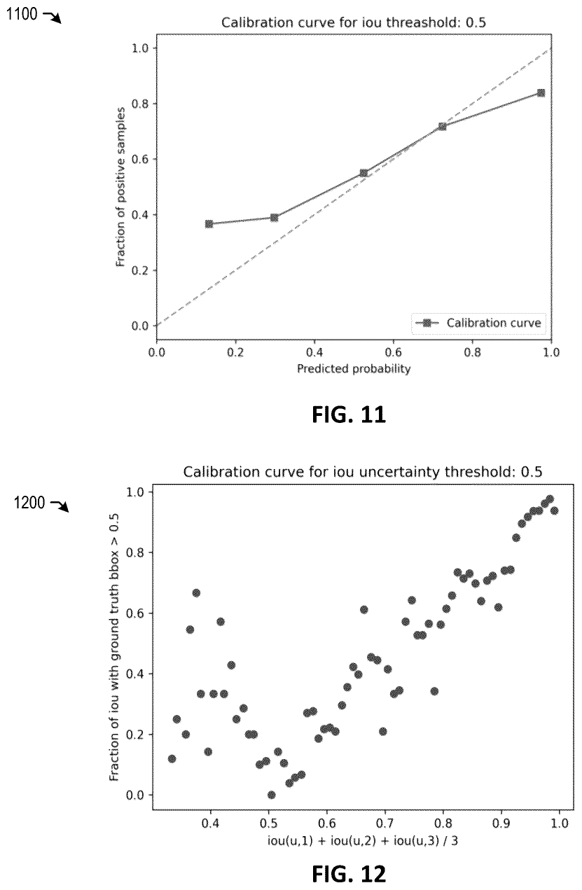

In turn, machine learning model training system 750 downloads the LIDAR frame data from offboard storage 730 and trains machine learning model 710, or a representation of machine learning model 710 in machine learning model training system 750, using the LIDAR frame data. In some embodiments, machine learning model training system 750 uses the downloaded LIDAR frame data to better train machine learning model 710 to recognize certain objects, such as traffic signs in foreign counties, different landscape objects (trees versus buildings), etc. In some embodiments, machine learning model training system 750 uses the downloaded LIDAR frame data to better train machine learning model 710 to determine bounding boxes or locations of bounding boxes corresponding to obstacles (see FIG. 11 and corresponding text for further details).

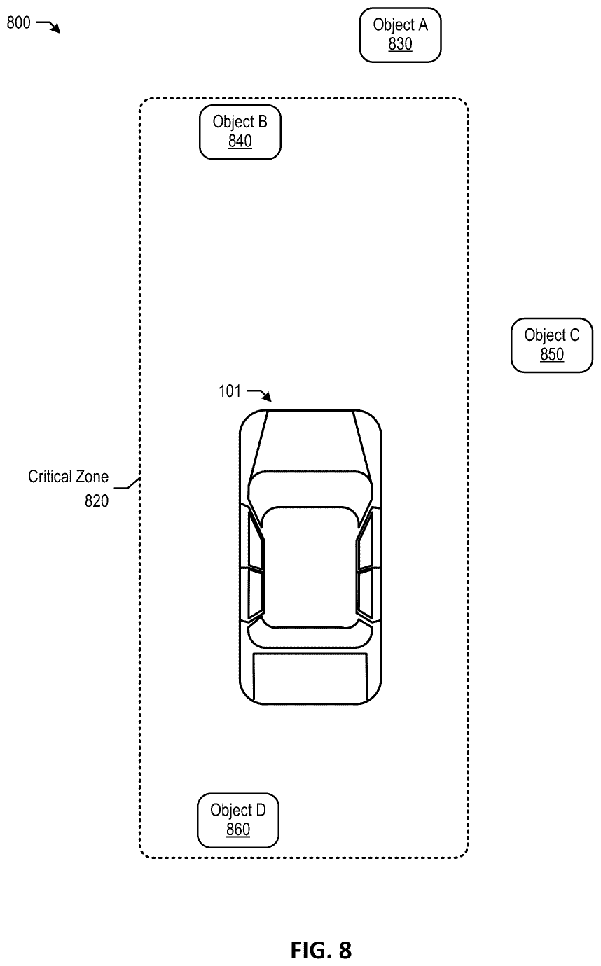

FIG. 8 is a diagram illustrating an example of ADS 110 evaluating locations of objects relative to a critical zone surrounding ADV 101. Obstacle distances from ADV101 are an important consideration to ADS 110 (e.g., upload manager 720) when determining whether to upload LIDAR frame data when their corresponding confidence values are below the confidence threshold. For example, point cloud data for far away obstacles may include substantial noise merely due to the distance of the object. As such, in some embodiments, upload manager 720 disregards confidence values corresponding to objects outside critical zone 820. This ensures that the high uncertainty is from the insufficient recognition ability of the machine learning model 710 rather than the far distance. In some embodiments, a rectangular frame area of obstacles can also be used to filter out obstacles that are too small to consider, which can effectively reduce noise. However, it should be noted that if this area is set too large, some small obstacles may be missed.

In some embodiments, a critical zone 820 is established to filter out far away objects. For example, critical zone 820 may be less than or equal to 20 meters in front of ADV 101; 3 meters behind ADV 101, and less than or equal to 8 meters on each side of ADV 101. Using the example shown in Figure, confidence values for objects A 830 and C 850 are not evaluated, but confidence values for objects B 840 and D 860 are evaluated.

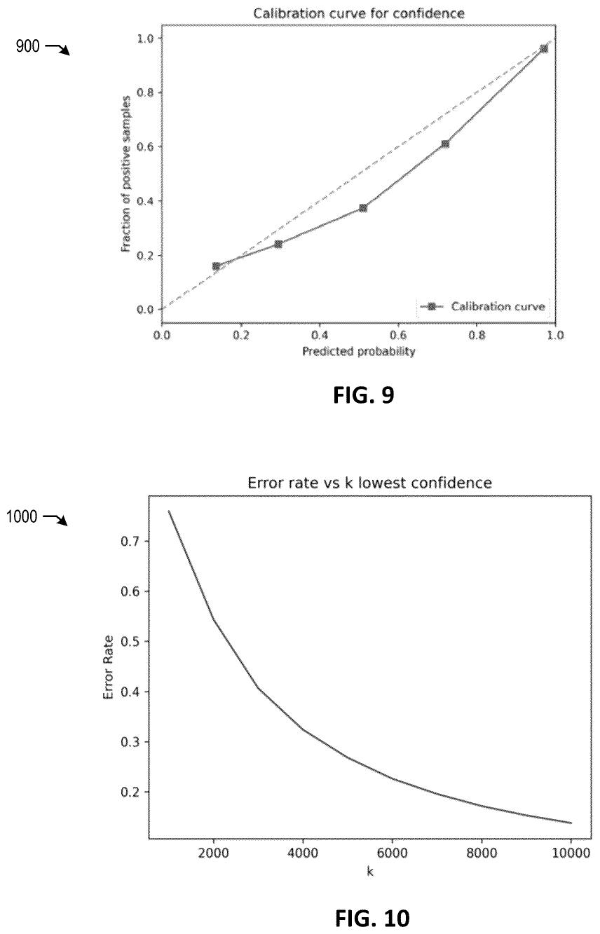

FIG. 9 is a diagram illustrating an example of a calibration curve for confidence graph, in accordance with some embodiments. To validate or determine the onboard data mining parameters, a calibration curve of label prediction for obstacles inside critical zone 820 may be plotted. Graph 900 includes a calibration curve that illustrates a relationship between the predicted probability of a machine-learning model (x-axis) and the true probability of the corresponding outcome (y-axis). It is used to measure the accuracy and reliability of a model's predictions. The calibration curve determines how well the predicted probabilities from a model match with the actual probabilities of the events the machine learning model is trying to predict. A well-calibrated model should assign probabilities that are as close as possible to the true probabilities of the outcomes. In addition, the calibration curve can be used to identify if a model is overconfident or underconfident in its predictions. An overconfident model may assign high probabilities to outcomes that are unlikely to occur, while an underconfident model may assign low probabilities to outcomes that are likely to occur. The X-axis is the model-predicted confidence and the y-axis is the fraction of correct prediction. Graph 900 shows that with low-confidence data on the x-axis, the fraction of correct prediction is also low (y-axis). As the confidence grows, the fraction of correct prediction is increased accordingly. As such, graph 900 shows that mining with low-confidence data is advantageous to finding more wrong predictions.

FIG. 10 is a diagram illustrating an example of an error rate versus k lowest confidence graph, in accordance with some embodiments. To continue to validate or determine the size of critical zone 820 and the onboard data mining parameters, the lowest K confidence value results are extracted to calculate the error rate. Graph 1000 shows an error rate for the top K low confidence result. As K becomes larger (x-axis), the error rate (y-axis) drops substantially. As such, there is a high likelihood to mine the erroneous data using low confidence values.

FIG. 11 is a diagram illustrating an example of a calibration curve for an intersection. To continue to validate or determine the size of critical zone 820 and the onboard data mining parameters, the calibration curve of an intersection of union (IoU) for obstacles inside the critical zone is plotted and frames are filtered out using, in some embodiments, the following criteria: T_thresh=0.5, obstacle inside critical zone, and obstacle area >1m\hat{ }2. Graph 1100 shows the relationship between intersection over union (IoU) versus confidence when a predicted label is true. IoU, also referred to as the Jaccard index, is a metric used to evaluate the accuracy of object detection and segmentation algorithms. IoU measures the overlap between a predicted bounding box or region and the ground truth bounding box or region. The IoU is calculated as the ratio of the intersection area between the predicted and ground truth regions to the union area of the two regions.

In some embodiments, for any predicted bounding box in a model, the bounding box bj in each of model j is found that satisfies the following two conditions: (1) have the maximum IoU among all the bounding boxes in that model; and (2) have the same label prediction with box a. If such a bounding box is not found, then IoU (a, bj)=0. As such, for m models, the uncertainty can be calculated as follows:

$$\frac{1}{m} {\sum }_{j = 1}^{m} IOU ( a , {b}_{j} )$$

In some embodiments, an (m, 6) matrix may also be used to represent all the bounding boxes (without duplicate) in one frame and calculate IoUs with ground truth label.

During times when machine learning model 710 predicts a correct label, the direction and size of bounding boxes are different than the ground truth, which results in a poor perception. Graph 1100 plots the calibration curve for IOU after filtering out the corrected predicted bounding boxes and calculating the IOU with the ground truth boxes. Graph 1100 shows that even with correct label prediction, low confidence usually indicates low IOU and indicates poor perception. In short, graph 1100 shows that, to optimize machine learning model 710, system 700 is correct to focus on uploading LIDAR frame data with low confidence values for machine learning model training system 750 to retrain machine learning model 710.

FIG. 12 is a diagram illustrating an example of a calibration curve for intersection of union threshold, in accordance with some embodiments. Graph 1200 shows that when the value of the x-axis is greater than 0.5, a linear relationship exists between x values and y values. This indicates that when the uncertainty is high (x is small) the fraction of positive sample is also low. However, when the value of x-axis is less than 0.5, the number of points is less and results in an instability of the fraction.

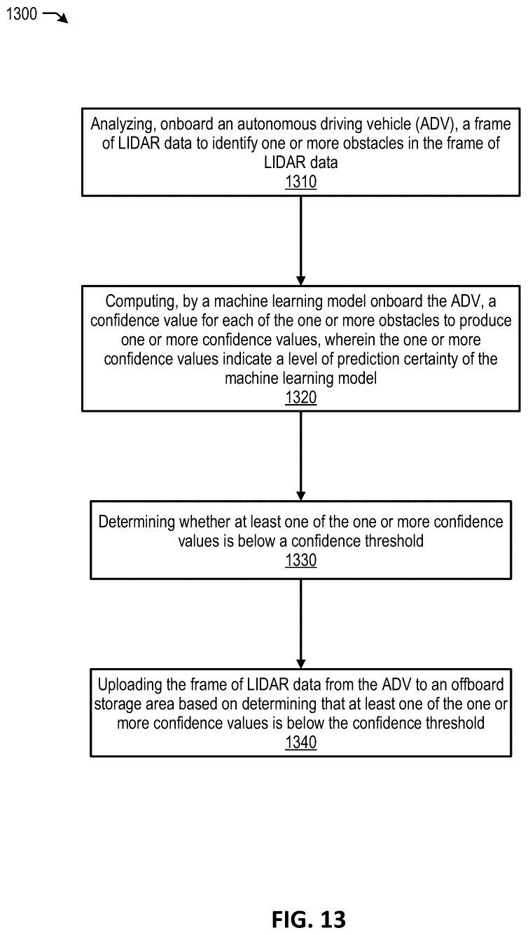

FIG. 13 is a flow diagram of a method for uncertainty-based data mining, in accordance with some embodiments. Method 1300 may be performed by processing logic that may include hardware (e.g., circuitry, dedicated logic, programmable logic, a processor, a processing device, a central processing unit (CPU), a system-on-chip (SoC), etc.), software (e.g., instructions running/executing on a processing device), firmware (e.g., microcode), or a combination thereof. In some embodiments, at least a portion of method 1300 may be performed by machine learning model 710, upload manager 720, machine learning model training system, or a combination thereof.

With reference to FIG. 13, method 1300 illustrates example functions used by various embodiments. Although specific function blocks (“blocks”) are disclosed in method 500, such blocks are examples. That is, embodiments are well suited to performing various other blocks or variations of the blocks recited in method 1300. It is appreciated that the blocks in method 1300 may be performed in an order different than presented, and that not all of the blocks in method 1300 may be performed.

With reference to FIG. 13, at block 1310, processing logic, on board ADV 101, analyzes a frame of LIDAR data to identify one or more obstacles in the frame of LIDAR data. For example, the LIDAR frame data may identify a person, a dog, and a bicycle.

At block 1320, processing logic computes, by a machine learning model onboard the ADV, a confidence value for each of the one or more obstacles to produce one or more confidence values, wherein the one or more confidence values indicate a level of prediction certainty of the machine learning model. For example, the confidence values of the objects may be. 1-person, .6-dog, and .02-bicycle.

At block 1330, processing logic determines whether at least one of the one or more confidence values is below a confidence threshold. In some embodiments, processing logic determines an amount of uploaded LIDAR data that is uploaded to the offboard storage area over a period of time, and adjusts the confidence threshold based on comparing the amount of uploaded LIDAR data to an upload threshold.

At block 1340, processing logic uploads the frame of LIDAR data from the ADV to an offboard storage area based on determining that at least one of the one or more confidence values is below the confidence threshold. In some embodiments, in response to determining that one of the one or more obstacles corresponds to a confidence level below the confidence threshold, processing logic determines a location the obstacle relative to the ADV, compares the location of the obstacle to a critical zone surrounding the ADV, and performing the uploading when the location of the obstacle is within the critical zone. In some embodiments, processing logic cancels the uploading of the frame of LIDAR data when the location of the obstacle is outside the critical zone. In some embodiments, processing logic cancels the uploading of the frame of LIDAR data when the low confidence obstacle has a bounding box with an area below a predetermined threshold.

In some embodiments, processing logic identifies one or more adjacent frames of LIDAR data that are adjacent to the frame of LIDAR data, and prohibits the one or more adjacent frames of LIDAR data from being uploaded to the offboard storage area.

Note that some or all of the components as shown and described above may be implemented in software, hardware, or a combination thereof. For example, such components can be implemented as software installed and stored in a persistent storage device, which can be loaded and executed in a memory by a processor (not shown) to carry out the processes or operations described throughout this application. Alternatively, such components can be implemented as executable code programmed or embedded into dedicated hardware such as an integrated circuit (e.g., an application specific IC or ASIC), a digital signal processor (DSP), or a field programmable gate array (FPGA), which can be accessed via a corresponding driver and/or operating system from an application. Furthermore, such components can be implemented as specific hardware logic in a processor or processor core as part of an instruction set accessible by a software component via one or more specific instructions.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as those set forth in the claims below, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments of the disclosure also relate to an apparatus for performing the operations herein. Such a computer program is stored in a non-transitory computer readable medium. A machine-readable medium includes any mechanism for storing information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices).

The processes or methods depicted in the preceding figures may be performed by processing logic that comprises hardware (e.g., circuitry, dedicated logic, etc.), software (e.g., embodied on a non-transitory computer readable medium), or a combination of both. Although the processes or methods are described above in terms of some sequential operations, it should be appreciated that some of the operations described may be performed in a different order. Moreover, some operations may be performed in parallel rather than sequentially.

Embodiments of the present disclosure are not described with reference to any particular programming language. It will be appreciated that a variety of programming languages may be used to implement the teachings of embodiments of the disclosure as described herein.

In the foregoing specification, embodiments of the disclosure have been described with reference to specific exemplary embodiments thereof. It will be evident that various modifications may be made thereto without departing from the broader spirit and scope of the disclosure as set forth in the following claims. The specification and drawings are, accordingly, to be regarded in an illustrative sense rather than a restrictive sense.

What is claimed is:

1. A computer-implemented method, comprising:
analyzing, onboard an autonomous driving vehicle (ADV), a frame of LIDAR data to identify one or more obstacles in the frame of LIDAR data;
computing, by a machine learning model onboard the ADV, a confidence value for each of the one or more obstacles to produce one or more confidence values, wherein the one or more confidence values indicate a level of prediction certainty of the machine learning model;
determining whether at least one of the one or more confidence values is below a confidence threshold; and
uploading the frame of LIDAR data from the ADV to an offboard storage area based on determining that at least one of the one or more confidence values is below the confidence threshold.

2. The method of claim 1 further comprising:
in response to determining that one of the one or more obstacles corresponds to a confidence level below the confidence threshold, determining a location of the obstacle relative to the ADV;
comparing the location of the obstacle to a critical zone surrounding the ADV; and
performing the uploading when the location of the obstacle is within the critical zone.

3. The method of claim 2, further comprising:
cancelling the uploading of the frame of LIDAR data when the location of the obstacle is outside the critical zone.

4. The method of claim 1, further comprising:
determining an amount of uploaded LIDAR data that is uploaded to the offboard storage area over a period of time; and
adjusting the confidence threshold based on comparing the amount of uploaded LIDAR data to an upload threshold.

5. The method of claim 1, further comprising:
identifying one or more adjacent frames of LIDAR data that are adjacent to the frame of LIDAR data; and
prohibiting the one or more adjacent frames of LIDAR data from being uploaded to the offboard storage area.

6. The method of claim 1, wherein the uploaded frame of LIDAR data is utilized to train the machine learning model on the one or more obstacles corresponding to the one or more confidence values that are below the confidence threshold.

7. The method of claim 1, wherein the uploaded frame of LIDAR data is utilized to train the machine learning model on determining one or more bounding boxes of the one or more obstacles corresponding to one or more confidence values.

8. A system comprising:
a processing device; and
a memory to store instructions that, when executed by the processing device cause the processing device to:
analyze, onboard an autonomous driving vehicle (ADV), a frame of LIDAR data to identify one or more obstacles in the frame of LIDAR data;
compute, by a machine learning model onboard the ADV, a confidence value for each of the one or more obstacles to produce one or more confidence values, wherein the one or more confidence values indicate a level of prediction certainty of the machine learning model;
determine whether at least one of the one or more confidence values is below a confidence threshold; and
upload the frame of LIDAR data from the ADV to an offboard storage area based on determining that at least one of the one or more confidence values is below the confidence threshold.

9. The system of claim 8, wherein the processing device further to:
determine a location the obstacle relative to the ADV;
compare the location of the obstacle to a critical zone surrounding the ADV; and
upload the frame of LIDAR data when the location of the obstacle is within the critical zone.

10. The system of claim 9, wherein the processing device further to:
cancel the upload of the frame of LIDAR data when the location of the obstacle is outside the critical zone.

11. The system of claim 8, wherein the processing device further to:
determine an amount of uploaded LIDAR data that is uploaded to the offboard storage area over a period of time; and
adjust the confidence threshold based on comparing the amount of uploaded LIDAR data to an upload threshold.

12. The system of claim 8, wherein the processing device further to:
identify one or more adjacent frames of LIDAR data that are adjacent to the frame of LIDAR data; and
prohibit the one or more adjacent frames of LIDAR data from being uploaded to the offboard storage area.

13. The system of claim 8, wherein the uploaded frame of LIDAR data is utilized to train the machine learning model on the one or more obstacles corresponding to the one or more confidence values that are below the confidence threshold.

14. The system of claim 8, wherein the uploaded frame of LIDAR data is utilized to train the machine learning model on determining one or more bounding boxes of the one or more obstacles corresponding to one or more confidence values.

15. A non-transitory machine-readable medium having instructions stored therein, which when executed by a processor, cause the processor to perform operations, the operations comprising:
analyzing, onboard an autonomous driving vehicle (ADV), a frame of LIDAR data to identify one or more obstacles in the frame of LIDAR data;
computing, by a machine learning model onboard the ADV, a confidence value for each of the one or more obstacles to produce one or more confidence values, wherein the one or more confidence values indicate a level of prediction certainty of the machine learning model;
determining whether at least one of the one or more confidence values is below a confidence threshold; and
uploading the frame of LIDAR data from the ADV to an offboard storage area based on determining that at least one of the one or more confidence values is below the confidence threshold.

16. The non-transitory machine-readable medium of claim 15, wherein the operations further comprise:
in response to determining that one of the one or more obstacles corresponds to a confidence level below the confidence threshold, determining a location the obstacle relative to the ADV;
comparing the location of the obstacle to a critical zone surrounding the ADV; and
performing the uploading when the location of the obstacle is within the critical zone.

17. The non-transitory machine-readable medium of claim 16, wherein the operations further comprise:
cancelling the uploading of the frame of LIDAR data when the location of the obstacle is outside the critical zone.

18. The non-transitory machine-readable medium of claim 15, wherein the operations further comprise:
determining an amount of uploaded LIDAR data that is uploaded to the offboard storage area over a period of time; and
adjusting the confidence threshold based on comparing the amount of uploaded LIDAR data to an upload threshold.

19. The non-transitory machine-readable medium of claim 15, wherein the operations further comprise:
identifying one or more adjacent frames of LIDAR data that are adjacent to the frame of LIDAR data; and
prohibiting the one or more adjacent frames of LIDAR data from being uploaded to the offboard storage area.

20. The non-transitory machine-readable medium of claim 15, wherein the uploaded frame of LIDAR data is utilized to train the machine learning model on the one or more obstacles corresponding to the one or more confidence values that are below the confidence threshold, and utilized to train the machine learning model on determining one or more bounding boxes of the one or more obstacles corresponding to one or more confidence values.
